(19) United States
(12) Patent Application Publication
(10) Pub. No.: US 2002/0039061 A1
(43) Pub. Date: Apr. 4, 2002

(54) Magnetically biased inductor or flyback transformer

(76) Inventor: Alexander Timashov, Rehovot (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/950,661

(22) Filed: Sep. 13, 2001

(30) Foreign Application Priority Data
Oct. 3, 2000 (IL) 138834

(51) Int. Cl. H01F 17/06

(52) U.S. Cl. 336/175

(57) ABSTRACT

The invention relates to inductors or flyback transformers provided with a device that opposes the saturating flux in a core.

The device comprises at least one E-shaped ferromagnetic core, the two outer limbs only of the E being provided each with an air gap relative to an adjoining core component; and two permanent magnets, installed one adjacent to each said air gap, oriented so to direct the flux between the magnet poles in a direction opposed to the flux direction generated in said core by DC current when said core is in use; and a coil for generating an electric field, positioned around the central limb of said E-shaped ferrite core, whereby when said coil is powered the major portion of generated flux transverses the air gaps and only a minor portion thereof flows through the magnets.

### CROSS-REFERENCE TO RELATED APPLICATIONS

This application claims priority of Israeli application serial number 138834, filed on Oct. 3, 2000.

### FIELD AND BACKGROUND OF THE INVENTION

The present invention relates to improvements in inductors and in flyback transformers. More particularly, the invention provides an inductor or a flyback transformer having a device, that opposes the saturating flux in a core, providing an improved inductance/size ratio.

An inductor is an electromagnetic device which is used, for example, in switched mode Power supply (SMPS) to produce a magnetic field in response to an electric current flowing through its coils.

Inductors are also used as a filter choke, for reducing ripple amplitude in an electric current being fed from a power source, for example a switched mode power supply, to a load, for an example Information Technology Equipment, in which case the magnetic field Set Up is of no interest. What is important is that the inductor presents a high impedance to the AC component of the power source voltage, while DC component is practically free to pass, aside from ohmic losses.

A particular type of transformer called a fly-back transformer is used in several topologies of SMPS. The inductor device of the present invention is well suited for use as part of such transformer.

In application as a choke, inductors may be used, as stated, to carry superimposed AC and DC currents. In such cases the soft iron core of the inductor becomes saturated mainly by the DC component, and effectiveness of the inductor declines rapidly.

It has long been known that core saturation can be combated to a significant degree by introducing an air gap in part of the magnetic circuit. Compared to a similar, in core and in coil inductor, the introduction of a gap in inductor decreases the overall magnetic permeability, i.e. decreases inductance. A higher magneto motive force (MMF) can be tolerated until saturation is reached and the inductor current rating is increased. However the cost of such gap, is, as stated, reduced permeability in the whole core. The air gap acts as if the length of the magnetic path had been increased, decreasing inductance. This translates into a requirement to increase the physical dimensions of the whole inductor or transformer, with obvious weight, space and cost penalties.

In U.S. Pat. No. 3,968,465 Fukui et al. propose an elegant solution to the drawbacks of the air gap in a device where AC and DC currents flow and overlap. They describe the placement of a plurality of small permanent magnets into the air gap, the magnetizing direction of the magnets being opposed to and offsetting that of a DC magnetic field produced in the magnetic circuit. To reduce eddy current losses and consequent undesirable heating in the magnets, Fukui et al. specify the use of many small magnets.

In practice it has been found that the problem of eddy-currents in the magnets was not solved satisfactorily. Using low-cost hard ferrite permanent magnets, Fukui-type inductors suffered from such severe magnet heating that the magnets were often permanently demagnetized in use. Other devices were built using rare earth magnets, these being more resistant to demagnetization, but there are many applications where this cannot be done due to material costs being too high.

Ray in U.S. Pat. No. 4,491,819 proposes the addition of a magnetic shield to surround the air gap and to return stray flux back into the magnetic circuit. The shield reduces radiated electromagnetic noise. Ray specifies the use of rare earth magnets.

The problem of eddy current heating of the magnets is of course particularly severe where high frequencies are being handled. For example, in SMPS applications, which commonly operate at hundreds of kilohertz. To reduce eddy current losses it is possible to use many smaller magnets, as Fukui et al. proposed, but in practice the installation of a multitude of small magnets is not economically attractive.

### OBJECTS OF THE INVENTION

It is therefore one of the objects of the present invention to obviate the disadvantages of prior art magnetically biased inductors and to provide an inductor which resists overheating and demagnetization.

It is a further object of the present invention to provide an inductor suitable for high-frequency power.

It is a further object of the present invention to provide a device which provides similar advantages when used in a fly-back transformer.

Yet a further object of the present invention is to provide an inductor or a flyback transformer with an improved power capacity/weight ratio, as well as better power capacity/volume ratio and power capacity/cost ratios.

### SUMMARY OF INVENTION

The present invention achieves the above objects by providing an inductor device that opposes the saturating flux in a magnetic core comprising;

a) at least one E shaped ferromagnetic core, the two outer limbs only of the E being provided each with an air gap relative to an adjoining core component;

b) two permanent magnets, installed one adjacent to each said air gap, oriented so to direct the flux between the magnet poles in a direction opposed to the flux direction generated in said core by DC current when said core is in use; and

c) a coil for generating an electric field, positioned around the central limb of said E-shaped ferrite core,

whereby when said coil is powered the major portion of generated flux transverses said air gaps and only a minor portion thereof flows through said magnets.

In a preferred embodiment of the present invention there is provided an inductor device wherein said adjacent core component comprises a second E shaped soft ferrite core, arranged so that the open sides of said E shapes face each other.

In a most preferred embodiment of the present invention there is provided an inductor device wherein said coil comprises a plurality of planar circuits separated by insulators.

Yet further embodiments of the invention will be described hereinafter.

It will thus be realized that in the novel device of the present invention the greater part of the flux due to DC current does not pass through the magnets. This arrangement makes possible the use of low-cost magnets, and allows high frequencies to be handled without overheating. The magnets are easily installed as they are made of one piece and not broken up into a multitude of small units.

In a preferred embodiment of the inductor or flyback transformer device, the coil, instead of being made only of common insulated copper wire comprises planar copper strips, thus reducing skin and proximity effects while allowing operation at higher frequencies.

While some temperature rise is inevitable in any operating inductor device, such heating can be controlled by connection to a heatsink. In the present invention the flat outer surface forming the back face of the E form is ideal for attachment thereto.

The advantages of the inductor device of the present invention can be summarized as follows:

a. Reduction of electrical losses in the magnets allows increasing the frequency of the AC ripple in the inductor.

b. When the inductor device is used in a flyback transformer, the operating AC voltage may be increased.

c. There is no need to divide the magnets into small pieces, which greatly simplifies manufacture and assembly.

d. As the major part of the flux generated by the DC current does not pass through the magnets, higher DC currents are allowed as compared with prior art inductors.

e. Magnet costs are reduced, as common ferrite materials can be used, and there is no need for rare earth magnets.

f. Easy assembly of the magnet pieces.

With regard to embodiments wherein the coil comprises a plurality of planar circuits separated by insulators, such coils are the subject of a co-pending patent application Ser. No. 136301 which provides full details thereof. The present invention is independent of this type of coil, as a conventional coil of insulated copper wire may be used instead, as will be seen in FIGS. 1 and 2.

### SHORT DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1 is a perspective enlarged view of a preferred embodiment of the inductor device according to the invention, the upper face being fragmented to reveal inner details;

FIG. 2 is a perspective view of a double E embodiment;

FIG. 3 is a perspective view of an EI embodiment provided with planar coil circuits; and

FIG. 4 is a perspective view of a double E embodiment, provided with planar coil circuits.

### DISCLOSURE OF THE INVENTION

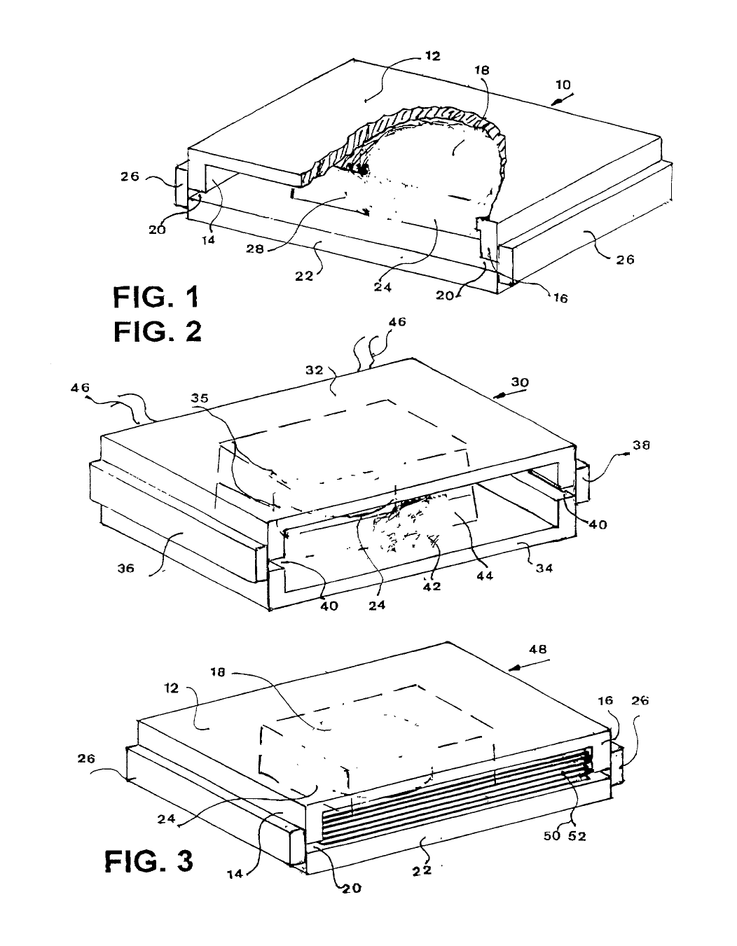

There is seen in FIG. 1 a first embodiment of an inductor device 10 having the device which opposes the saturating magnetic flux in the core. The figure shows an EI type core form.

An E shaped soft ferrite core comprises a back surface 12 and three limbs 14, 16, 18. The two outer limbs 14, 16 are provided each with an air gap 20 relative to an adjoining core component. In the present embodiment the adjacent core component is an I-shaped soft ferrite core 22, The center limb 18 of the E is shown as having a round cross-section, for magnetical electrical reasons. The end face 24 of the center limb 18 is in flush contact with, and preferably attached to the upper surface of the I-shaped core 22.

Two permanent magnets 26 are rigidly fixed in place, and installed adjacent to and outside of each air gap 20. The magnets 26 are oriented so as to direct the flux between their magnet poles in a direction opposed to the flux direction generated in the device 10 by DC current when the device is powered in use. Preferably the permanent magnets 26 are magnetized along their width. Advantageously the permeability of the E-shaped ferrite core and the permeability of the magnets 26 are arranged to cause the major portion of generated magnetic flux to transverse the air gaps 20 and only a minor portion thereof to flow through the magnets 26. The permanent magnets 26 are made of a low-cost hard ferrite material. It is possible but not necessary to use rare earth magnets.

A coil 28 generating an electric field is positioned and wound around the central limb 18 of the E-shaped ferrite core. In the present embodiment the coil 28 comprises insulated copper wire.

With reference to the rest of the figures, similar reference numerals have been used to identify similar parts.

Referring now to FIG. 2, there is seen an inductor device 30 wherein the adjacent component to a first E core 32 comprises a second E shaped soft ferrite core 34. The two cores 32, 34 are arranged so that the open sides of the E shapes face each other. The central limbs 35 of the two E cores are in direct contact with each other and may be joined together.

A permanent magnet 36 is attached to the left and a second magnet 38 at the right of the E as seen in the diagram. Thus the two E cores 32, 34 are interconnected but are in direct contact only because the center limbs of the E 35 abut each other. The magnets 36, 38 are positioned outside the air gaps 40 separating the outer limbs of the cores.

The present embodiment 30 has a primary 42 and a secondary coil 44 and at least four terminals 46, being part of a fly-back transformer as used in some SMPS.

FIG. 3 illustrates an inductor device 48 similar to 10 seen in FIG. 1. The coil comprises a plurality of planar circuits 50 separated by insulators 52, too thin to be visible, and there are usually no insulated winding wire. The planar circuits 50 are interconnected in series to form a coil. Interconnections are in parallel where heavy currents are to be handled. Planar circuits are not the subject of the present application, but are fully described in our co-pending patent application Ser. No. 136301.

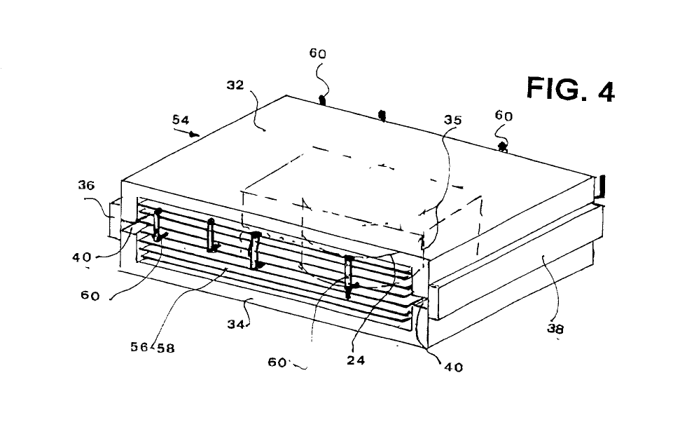

Seen in FIG. 4 is a transformer device 54 similar to the inductor device 30 seen in FIG. 2, provided with a plurality of planar circuits 56 separated by insulators 58 as in FIG. 3. Some of the planar circuits 56 are interconnected to form the primary side of the transformer while others are interconnected to form the secondary side. The transformer device 54 may be operated at high frequencies, and if necessary cooled by the attachment of a heat sink (not shown) or by forced air circulation. As with any transformer, at least four terminals 60 are provided.

The scope of the described invention is intended to include all embodiments coming within the meaning of the following claims. The foregoing examples illustrate useful forms of the invention, but are not to be considered as limiting its scope, as those skilled in the art will readily be aware that additional variants and modifications of the invention can be formulated without departing from the meaning of the following claims.

We claim:

1. An inductor device or a flyback transformer having a device which opposes the saturating magnetic flux in their core, comprising;
a) At least one E shaped soft ferromagnetic core, the two outer limbs only of the E being provided each with an air gap relative to an adjoining core component;
b) Two permanent magnets, installed one adjacent to each said air gap, oriented so to direct the flux between their magnet poles in a direction opposed to the flux direction generated in said cores by DC current when said inductor/flyback transformer is in use; and
c) A coil for generating a magnetic field, positioned around the central limb of said E-shaped ferromagnetic core, whereby when said coil is powered the major portion of generated flux transverses said air gaps and only a minor portion thereof flows through said magnets.

2. The inductor/flyback transformer device as claimed in claim 1, wherein said permanent magnets are magnetized along their width.

3. The inductor/flyback transformer device as claimed in claim 1, wherein the permeability of said E-shaped ferromagnetic core and the permeability of said magnets are arranged to cause the major portion of generated magnetic flux to transverse said air gaps and only a minor portion thereof to flow through said magnets.

4. The inductor/flyback transformer device as claimed in claim 1, wherein said permanent magnets are made of a hard ferrite material.

5. The inductor/flyback transformer device as claimed in claim 1, wherein said adjacent core component comprises a second E shaped ferromagnetic core, arranged so that the open sides of said E shapes face each other.

6. The inductor/flyback transformer device as claimed in claim 1, wherein said coil comprises a plurality of planar circuits separated by insulators.

7. The inductor/flyback transformer device as claimed in claim 5, being part of a fly-back transformer.
